(19) United States
(12) Patent Application Publication
(10) Pub. No.: US 2006/0084377 A1
(43) Pub. Date: Apr. 20, 2006

(54) Method for controlling broadcasting signal transmission in wireless communication system providing broadcasting service and corresponding system

(75) Inventors: Jae-Young Lee, Seoul (KR); Kyung-Ha Lee, Seongnam-si (KR); Kwan-Soo Lee, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Gyeonggi-do (KR)

(21) Appl. No.: 11/222,910

(22) Filed: Sep. 9, 2005

(30) Foreign Application Priority Data
Sep. 10, 2004 (KR) 72576/2004

(51) Int. Cl. H04B 17/02

(52) U.S. Cl. 455/9; 455/522; 455/69

(57) ABSTRACT

Disclosed are a method for broadcasting signal transmission in a wireless communication system providing a broadcasting service and a corresponding wireless communication system. In such a method and a system, a terminal receives a signal transmitted from a repeater to calculate received performance information of the signal and then transmits the received performance information to an administration center if the received performance information is equal to or greater than a reference error value. The administration center controls the repeater based on the received performance information transmitted from the terminal. The repeater adjusts transmission signal intensity or a transmission angle based on a control signal transmitted from the administration center.

### PRIORITY

This application claims priority to applications entitled “Method for Controlling Broadcasting Signal Transmission in Wireless Communication System Providing Broadcasting Service and Corresponding System” filed in the Korean Industrial Property Office on Sep. 10, 2004 and assigned Serial No. 2004-72576, the contents of which are hereby incorporated by reference.

### BACKGROUND OF THE INVENTION

1. Field of the Invention

The present invention relates to a system and a method for controlling signal transmission in a wireless communication system, and more particularly to a system and a method for controlling broadcasting signal transmission in a wireless communication system providing a broadcasting service.

2. Description of the Related Art

In general, a wireless communication system is directed to addressing the mobility of a terminal in a code division multiple access (CDMA) wireless communication system, a universal mobile telecommunication service (UMTS) mobile communication system, etc. In addition to such systems, a digital multimedia broadcasting (hereinafter referred to as ‘DMB’) wireless communication system providing a DMB service has recently appeared as another wireless communication system.

A DMB service is a next generation digital broadcasting service which enables users to enjoy multi-channel multimedia broadcasting at a high quality level. This DMB service is usually applied to a portable terminal or an in-vehicle terminal, and may be further applied to a home.

In order to provide the DMB service, a broadcasting signal of 13.824 to 13.883 GHz is transmitted from a satellite digital multimedia broadcasting center to a satellite. Then, the satellite not only transmits a signal of 12.214 to 12.239 GHz to a terrestrial repeater so as to provide a signal of good quality to a terminal, but also transmits a signal of 2.630 to 2.655 GHz for being received directly by a terminal. The terrestrial repeater transmits a signal to a terminal located in an area which a satellite signal cannot reach. Thus, the terrestrial repeater demodulates the signal of 12.214 to 12.239 GHz received from the satellite, modulates the demodulated signal such that mobile received is possible even in a multi-fading environment such as a downtown area, and then finally outputs a signal of 2.630 to 2.655 GHz.

When a DMB terminal, which receives a signal via the terrestrial repeater, is located in a position where signals from a plurality of repeaters overlap as shown in FIG. 1, or the DMB terminal is located in a position where transmission signals from the repeaters cannot reach the DMB terminal as shown in FIG. 2, the DMB terminal cannot properly receive the signal. In a case where a received condition of the terminal is poor when it receives a signal from the repeater, signal performance of the repeater covering a corresponding area is analyzed and adjusted such that the terminal can receive an optimized signal.

However, if the signal performance of the repeater is so adjusted that a specific terminal can receive an optimized signal, a terminal, which uses the same repeater while being located in other area, may have a low received performance even though the received performance of the specific terminal is good.

In order to optimize received performances of all terminals, which receive a signal from a corresponding repeater, without adjusting the repeater such that only a specific terminal can receive an optimized signal, an administrator must investigate received performances of other terminals in other areas when a terminal has a good received performance in one area. That is, in order to optimize a received performance of a signal from a repeater with respect to all terminals, the administrator must analyze each and every repeater coverage area. Also, based upon the information analyzed in this way, the administrator must reconfigure a network, that is, readjust the repeater.

Consequently, there is a problem in that the repeater adjustment cannot be immediately updated in real-time because a lot of time and effort are required to optimize the received performances of all of the terminals.

### SUMMARY OF THE INVENTION

Accordingly, the present invention has been made to solve at least the above-mentioned problems occurring in the prior art, and an object of the present invention is to provide a method for controlling broadcasting signal transmission in a wireless communication system providing a broadcasting service and a corresponding wireless communication system.

A further object of the present invention is to provide a real-time method and a real-time apparatus for controlling repeater adjustment for optimizing the signal received performance of a DMB terminal.

In order to accomplish this object, in accordance with one aspect of the present invention, there is provided a wireless communication system capable of providing a broadcasting service, the system includes a terminal for receiving a signal transmitted from a repeater to generate received performance information of the signal and for transmitting the received performance information if the received performance information is equal to or greater than a reference error value; and an administration center for receiving the received performance information and for controlling the repeater based on the received performance information transmitted from the terminal and transmitting a control signal to the repeater wherein the repeater adjusts a transmission signal intensity or a transmission angle based on the control signal.

In order to accomplish the above-mentioned object, in accordance with another aspect of the present invention, there is provided a method for controlling broadcasting signal transmission in a wireless communication system which includes a terminal, a repeater and an administration center in order to provide a broadcasting service; the method including receiving by the terminal a signal transmitted from the repeater to calculate received performance information of the signal and transmitting the received performance information to the administration center if the received performance information is equal to or greater than a reference error value; generating by the administration center a control signal for controlling the repeater based on the received performance information transmitted from the terminal; and adjusting by the repeater transmission signal intensity or a transmission angle based on the control signal transmitted from the administration center.

### BRIEF DESCRIPTION OF THE DRAWINGS

The above and other objects, features and advantages of the present invention will be more apparent from the following detailed description taken in conjunction with the accompanying drawings, in which:

FIGS. 1 and 2 are diagrams illustrating a DMB terminal which receives signals from repeaters in a wireless communication system;

FIG. 3 is a diagram illustrating a structure of a DMB wireless communication system in accordance with a preferred embodiment of the present invention;

FIG. 4 is a diagram illustrating a communication concept between the DMB terminal and an administration center in accordance with a preferred embodiment of the present invention;

FIG. 5 is a diagram illustrating an internal structure of the DMB terminal in accordance with a preferred embodiment of the present invention;

FIG. 6 is a diagram illustrating an internal structure of the administration center in accordance with a preferred embodiment of the present invention;

FIG. 7 is a flowchart of signal flows between the DMB terminal, the administration center and the repeater for improving received performance;

FIG. 8 is a flowchart of a received signal-processing process in the DMB terminal in accordance with a preferred embodiment of the present invention; and

FIG. 9 is a flowchart of operation procedures of the administration center in accordance with a preferred embodiment of the present invention.

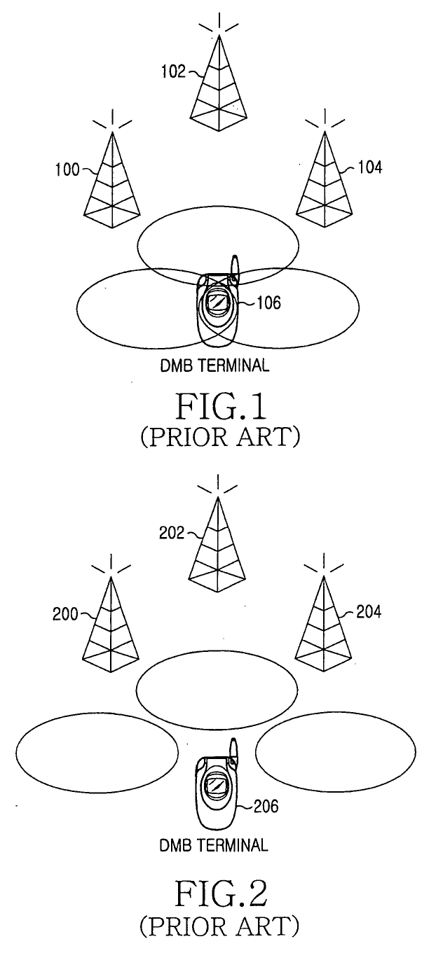

### DETAILED DESCRIPTION OF THE PREFERRED EMBODIMENT

Hereinafter, preferred embodiments of the present invention will be described with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

In the present invention, a terminal having a return path such as satellite DMB analyzes received performance of a signal received from a repeater and transmits received performance information to a central administration center such as a broadcasting center or a network administration center, thereby enabling the administration center to provide an optimal received condition to all terminals by adjusting the transmission angle of the repeater.

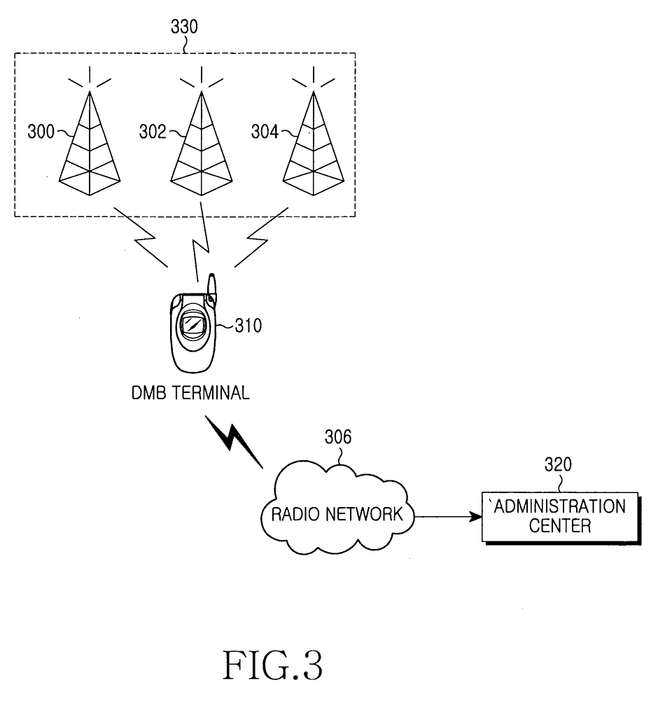

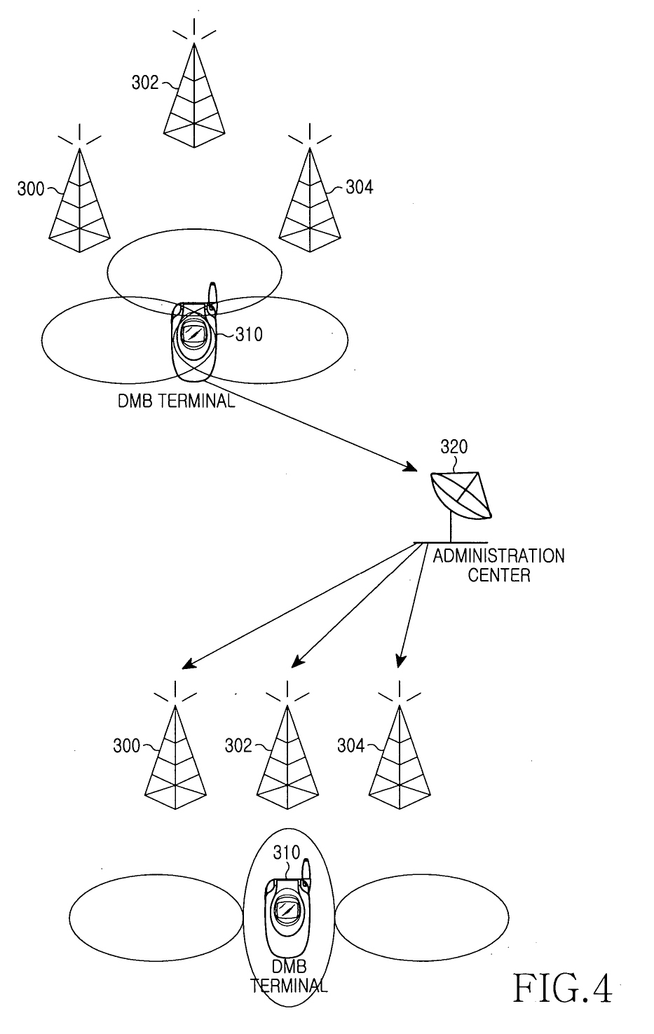

A wireless communication system including a DMB terminal, repeaters and an administration center will be described with reference to FIG. 3.

In order to provide a DMB service, a broadcasting center transmits a broadcasting signal of 13.824 to 13.883 GHz to a satellite. Then, the satellite transmits a signal of 12.214 to 12.239 GHz to repeaters 300, 302, 304 so as to provide a signal of good quality to a terminal. In FIG. 3, the satellite is not shown.

The repeaters 300, 302, 304, which receive the broadcasting signal from the satellite, transmits a signal to a terminal located in an area which a satellite signal cannot reach. The repeaters demodulate the signal of 12.214 to 12.239 GHz received from the satellite, modulate the demodulated signal such that mobile received is possible even in a multi-fading environment such as a downtown area, and then finally output a signal of 2.630 to 2.655 GHz.

A DMB terminal 310, which receives a signal from the repeaters 300, 302, 304, may be of various types such as a fixed type, a mobile type, an in-vehicle type and the like, and receives the signal directly from the satellite or via the repeaters 300, 302, 304.

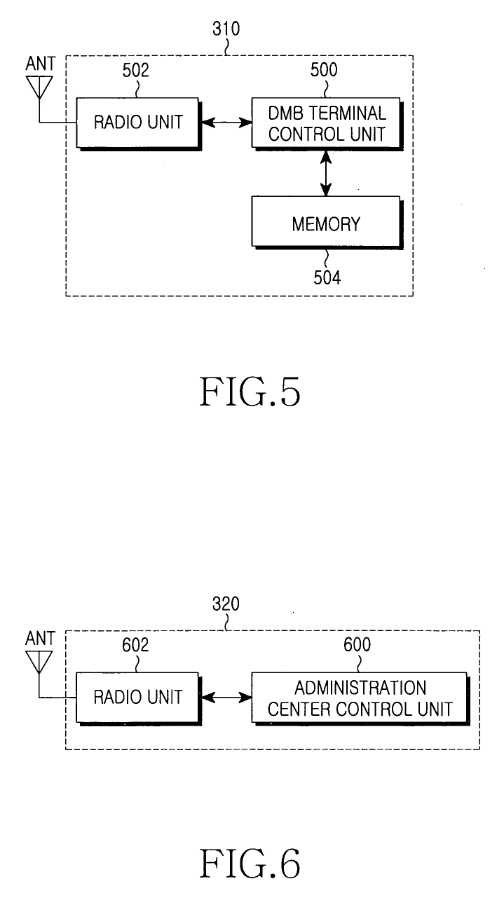

The DMB terminal 310 includes a DMB terminal control unit 500, a radio unit 502, an antenna ANT and a memory 504 as shown in FIG. 5.

The DMB signal received through an antenna is converted into a base band signal and subjected to signal processing such as demodulation, deinterleaving and so forth through the radio unit 502, and then the processed signal is output to the DMB terminal control unit 500.

The DMB terminal control unit 500, having received the output signal, processes the received signal and, in particular, calculates received signal intensity, a packet error rate, an individual bit error rate of the received signal according to the repeaters, and an integrated bit error rate for all the repeaters from the received signal. Information on the received signal intensity, the packet error rate, the individual bit error rate of the received signal according to the repeaters, and the integrated bit error rate for all the repeaters is referred to as received performance information.

The received performance information is listed below in Table 1.

TABLE 1

| Received | Repeater 300 | Repeater 302 | Repeater 304 |
|---|---|---|---|
| Performance | Received signal | Received signal | Received signal |
| information | intensity (dB) | intensity (dB) | intensity (dB) |
| | Packet error rate | Packet error rate | Packet error rate |
| | Individual bit error | Individual bit | Individual bit |
| | rate | error rate | error rate |

Integrated bit error rate

The DMB terminal control unit 500 transmits the received performance information examined from the received signal to an administration center 320 through the radio unit 502. At this time, the DMB terminal 310 transmits the received performance information to the administration center 320 over a radio network 306. The received performance information for the currently received signal can be an error value corrected in a Viterbi decoder.

Subsequently, the DMB terminal control unit 500 examines received performance information for signals consecutively received from the repeaters and compares the received performance information with an optimal received performance information stored in memory 504. If the current received performance information is not the same as the optimal received performance information, the current received performance information is transmitted to the administration center 320. The optimal received information is a reference error value below which the received performance information for a received signal is determined as good. That is, if an error value for the current received signal is below the reference error value, the received performance information for the current received signal is determined as good. If the current received performance information is not the same as the optimal received performance information and thus the DMB terminal control unit 500 transmits the current received performance information to the administration center 320, the administration center 320 controls the repeaters 300, 302, 304 by using the received performance information. Thus, in order to confirm whether or not the administration center 320 properly controls the repeaters 300, 302, 304, the DMB terminal control unit 500 must measure and transmit the received performance information for subsequent received signals.

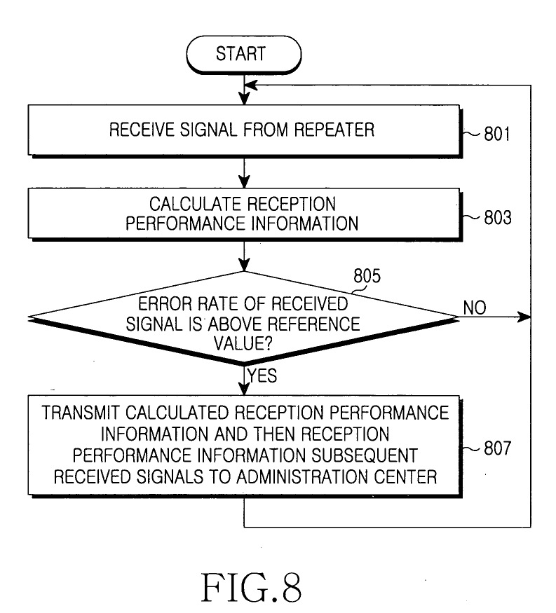

A description will be given for processing a received signal in the DMB terminal 310 of the present invention with reference to FIG. 8.

Referring to FIG. 8, if the DMB terminal 310 receives a signal transmitted from the repeater in step 801, the DMB terminal 310 calculates received performance information for the received signal in step 803. As stated above, the received performance information is information describing the received signal intensity, the packet error rate, the individual bit error rate of the received signal according to the repeaters, and the integrated bit error rate for all the repeaters.

The DMB terminal 310 then compares the calculated received performance information with an optimal received performance information to determine if the calculated information is the same as the optimal information. That is, the integrated error rate for the current received signal is compared with the reference error rate value. If the error rate for the current received signal is equal to or greater than the reference error rate value in step 805, the DMB terminal 310 proceeds to step 807 to transmit the calculated received performance information to the administration center 320. Also, the DMB terminal 310 transmits received performance information for a signal subsequently transmitted from the repeaters 300, 302, 304 to the administration center 320. This is because it is required to determine if the administration center 320 is properly controlling the repeaters 300, 302, 304 by using the received performance information transmitted from the DMB terminal 310 to the administration center 320.

If the error rate of the received signal is below the reference value in step 805, the DMB terminal 310 proceeds to step 801. That is, the DMB terminal 310 continues to receive a signal from the repeaters 300, 302, 304 and calculate received performance information for the received signal to transmit the calculated received performance information to the administration center 320 if necessary.

The administration center 320 having received the received performance information from the DMB terminal control unit 500 controls the repeaters 300, 302, 304 according to the received performance information such that received conditions of the respective DMB terminals are optimized. The administration center 320 may be the same system as the broadcasting center for providing the broadcasting service or a separate administration center only for network administration. An internal structure of the administration center 320 may be represented as shown in FIG. 6.

Referring to FIG. 6, the administration center 320 includes a control unit 600, a radio unit 602 and an antenna ANT. The radio unit 602 performs signal transmission/received with the repeaters 300, 302, 304 through an antenna and, in particular, performs transmission/received of information for controlling the repeaters 300, 302, 304, that is, received performance information and control information. The control unit 600 calculates transmission signal intensity or a transmission angle for each of the repeaters 300, 302, 304 by using the received performance information when it receives the received performance information. The control unit 600 also generates a control signal including the transmission signal intensity or the transmission angle according to the repeaters 300, 302, 304 and transmits the control signal to the each of the repeaters 300, 302, 304.

Each of the repeaters 300, 302, 304 having received the control signal adjusts its own transmission signal intensity or transmission angle based on the received control information. Then, a transmission radius of each of the repeaters is changed according to the control information of the administration center 320 as shown in FIG. 3, so the DMB terminal 310 can optimally receive the broadcasting signal.

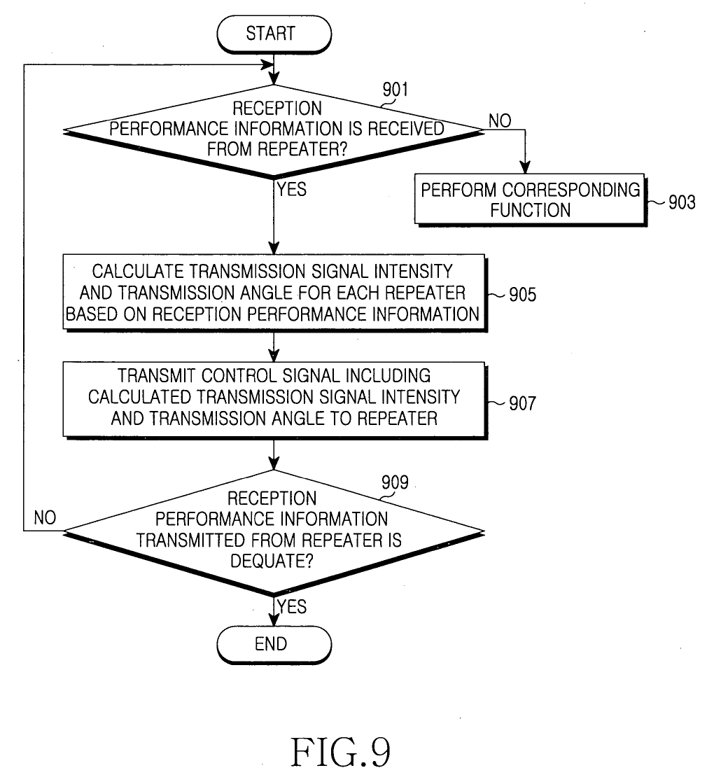

Operating procedures of the administration center 320 will be described in detail with reference to FIG. 9.

Referring to FIG. 9, in step 901, the administration center 320 determines if received performance information is received from the repeaters 300, 302, 304. If the received performance information is received, the administration center 320 calculates transmission signal intensity or a transmission angle for each of the repeaters 300, 302, 304 based on the received performance information so as to enhance the received performance of the DMB terminal 310 in step 905. Thereafter, the administration center 320 transmits control information including the calculated transmission signal intensity or transmission angle to each of the repeaters 300, 302, 304 in step 907.

Then, the each of the repeaters 300, 302, 304 adjusts its own transmission signal intensity or transmission angle according to the received control information. Subsequently, the DMB terminal 310 calculates received performance information of a signal transmitted from the adjusted repeaters 300, 302, 304 to transmit the received performance information to the repeaters 300, 302, 304. Thus, the administration center 320 receives the received performance information, which the DMB terminal 310 has transmitted, from the repeaters 300, 302, 304 to determine if the received performance information is adequate. The administration center 320 ends the procedures if the received performance information is adequate, but repeatedly performs steps 901 to 909 until the received performance information is adequate.

If the administration center 320 does not receive the received performance information in step 901, it performs its corresponding function in step 903. Since this procedure is not related to the present invention, a description thereof will be omitted.

As stated above, the DMB terminal 310 transmits to the administration center 320 signal information of a repeater from which the DMB terminal 310 currently receives a signal, that is, received performance information, and the administration center 320 adjusts a transmission angle and other transmission parameters of the corresponding repeater, which results in an optimal received condition of the terminal. If the administration center 320 controls each of the repeater 300, 302, 304 according to the received performance information transmitted from DMB the terminal 310, it can prevent the DMB terminal 310, which is located in a signal overlapping area of the repeaters or out of coverage areas of the repeaters, from improperly receiving the signal.

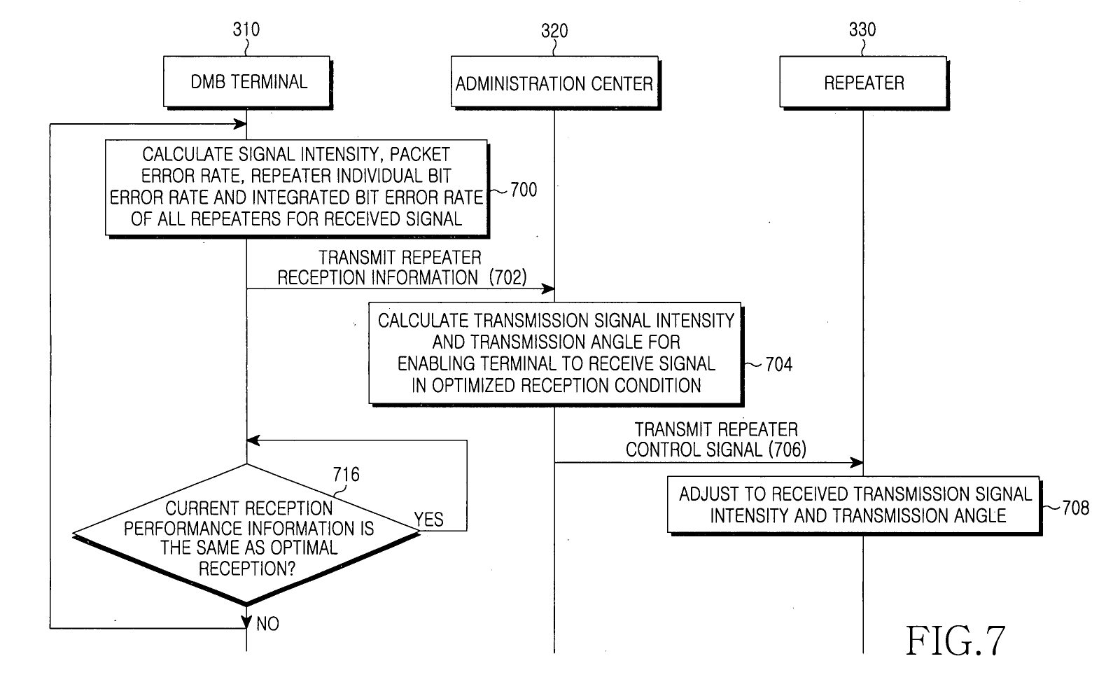

Now, with reference to FIG. 7, a description will be given for signal flows between the repeaters 300, 302, 304, the DMB terminal 310 and the administration center 320 for improving received performance of the DMB terminal 310 in the wireless communication system according to an embodiment of the present invention. FIG. 7 is a flowchart of signal flows between the DMB terminal, the administration center and the repeater for improving the received performance.

In step 700, the control unit 500 of the DMB terminal 310 examines received performance information for a signal received through the radio unit 502. Examining the received performance information refers to examining an individual bit error rate of a repeater from which the DMB terminal currently receives a signal or an integrated bit error rate for all the repeaters, a received signal intensity, a packet error rate, etc. The control unit 500 then transmits over the radio network the received performance information to the administration center 320 via the radio unit 502 in step 702. Although only one DMB terminal 310 is explained here, a plurality of DMB terminals examine the received performance information to transmit them to the administration center 320 in step 700.

In step 704, the control unit 600 of the administration center 320 calculates transmission signal intensity or a transmission angle of each of the repeaters based on information for all the repeaters, that is, the received performance information received from the plurality of DMB terminals including the DMB terminal 310 such that the DMB terminals in all areas can receive an optimized repeater signal. At this time, the received performance information transmitted from the DMB terminals is configured as shown above in Table 1.

In step 706, the control unit 600 of the administration center 320 transmits the calculated transmission signal intensity or transmission angle to the corresponding repeater in step 706. In order to optimize signal received performances of all the DMB terminals, the administration center 320 analyzes the information and controls the repeaters in real-time such that a good signal is prevented from being transmitted to only a specific area and the DMB terminals can receive the good signal in all areas.

In step 708, the repeater 330 having received control information from the administration center 320 adjusts its transmission signal and transmission angle to those included in the received control signal so as to enable the terminal currently located in its own repeater coverage area to receive an optimal signal.

Also, in step 710, the control unit 500 of the DMB terminal 310 compares the received performance information for the current received signal with the optimal received performance information stored in the memory 504. If the received performance information for the current received signal is not the same as the optimal received performance, the control unit 500 proceeds to step 700 to transmits the current received performance information to the administration center 320.

In addition, the administration center 320 controls the repeaters in real-time based on received performance information newly received from the DMB terminal 310.

In this way, steps 700 to 710 are repeatedly executed until the terminal is placed into an optimal received condition. If the received performance is improved, the improved status is maintained. If the received performance becomes worse, steps 700 to 710 are executed again.

As describe above, each of the DMB terminals 310 reports its received condition, that is, its received performance information to the administration center 320 in real-time, and the administration center 320 analyzes the received performance information and adjusts a signal performance, that is, the transmission signal intensity or the transmission angle of each of the repeaters 330 in real-time such that all the terminals can receive an optimized signal.

According to the present invention, the administration center assigns a repeater, which is optimized in real-time through received performance information transmitted from the terminal, to each of the terminals, so each of the terminals can always receive an optimized repeater signal and the terminal user can use a service of good quality.

The administration center controls the repeaters in real-time based on the received performances of all the terminals as in the present invention. The present invention can prevent other terminals in other areas from having bad received performances due to the fact that the repeater is adjusted for only one terminal in one area. Also, the administrator can reduce the time and effort required for making a round of all network areas for analysis of the repeater signal performance.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A wireless communication system capable of providing a broadcasting service, the system comprising:
a terminal for receiving a signal transmitted from a repeater to generate received information of the signal and for transmitting the received information if the received information is equal to or greater than a reference error value; and
an administration center for receiving the received information for generating a control signal based on the received information transmitted from the terminal, and transmitting the control signal to the repeater,
wherein the repeater adjusts a transmission signal intensity or a transmission angle based on the control signal transmitted from the administration center.

2. The system as claimed in claim 1, wherein the received information is based on at least one of received signal intensity, a packet error rate, an individual bit error rate of a received signal according to the repeaters, and an integrated bit error rate for all repeaters.

3. The system as claimed in claim 1, wherein the terminal transmits received information for subsequent received signals at least once again after transmitting the received information.

4. The system as claimed in claim 1, wherein the terminal comprises a radio unit for communicating with the repeater, a memory for storing the reference error value, and a control unit for performing signal processing and generating the received information for the signal transmitted from the repeater.

5. The system as claimed in claim 1, wherein the administration center determines if the received information transmitted from the terminal is adequate after transmitting the control signal to the repeater.

6. The system as claimed in claim 1, wherein the administration center comprises a radio unit for communicating radio signal received with the repeater, and a control unit for generating the control signal for controlling the transmission signal intensity or the transmission angle of the repeater based on the received information transmitted from the terminal.

7. A method for controlling broadcasting signal transmission in a wireless communication system which includes a terminal, a repeater and an administration center in order to provide a broadcasting service, the method comprising:
receiving by the terminal a signal transmitted from the repeater to calculate received information of the signal and transmitting the received information to the administration center if the received information is equal to or greater than a reference error value;
generating by the administration center a control signal for controlling the repeater based on the received information transmitted from the terminal; and
adjusting by the repeater the intensity and the angle of a transmission signal based on the control signal transmitted from the administration center.

8. The method as claimed in claim 7, wherein the received information is based on at least one of received signal intensity, a packet error rate, an individual bit error rate of a received signal according to the repeaters, and an integrated bit error rate for all repeaters.

9. The method as claimed in claim 7, further comprising the step of transmitting by the terminal received information for subsequent received signals at least once again after transmitting the received information in the first step.

10. The method as claimed in claim 7, further comprising the step of reconfirming by the administration center if the received information transmitted from the terminal is adequate after transmitting the control signal to the repeater.

11. An administration center for providing a broadcasting service to a terminal in a wireless communication system capable of providing the broadcasting service, the administration center comprising:
a radio unit for communicating radio signal received with a repeater; and
a control unit for generating a control signal for controlling the repeater based on received information transmitted from the terminal.

12. The administration center as claimed in claim 11, wherein the control unit calculates transmission signal intensity or a transmission angle of each of the repeaters based on the received information transmitted from the terminal.

13. The administration center as claimed in claim 11, wherein the control signal includes information on the transmission signal intensity or the transmission angle of each of the repeaters.

14. A method for controlling broadcasting signal transmission in an administration center for providing a broadcasting service to a terminal in a wireless communication system capable of providing the broadcasting service, the method comprising the steps of:
receiving received information transmitted from the terminal;
generating a control signal for controlling a repeater; and
transmitting the control signal to the repeater.

15. The method as claimed in claim 14, further comprising the step of confirming if the received information transmitted from the terminal is adequate after transmitting the control signal to the repeater.

16. The method as claimed in claim 14, wherein the control signal includes transmission signal intensity or a transmission angle of each of the repeaters.

17. A terminal for being provided with a broadcasting service from an administration center in a wireless communication system capable of providing the broadcasting service, the terminal comprising:
a radio unit for communicating with a repeater;
a control unit for calculating received information for a signal transmitted from the repeater and transmitting the received information if the received information is equal to or greater than a reference error value; and
a memory for storing the reference error value.

18. The terminal as claimed in claim 17, wherein the received information is based on at least one of received signal intensity, a packet error rate, an individual bit error rate of a received signal according to the repeaters, and an integrated bit error rate for all repeaters.

19. The terminal as claimed in claim 17, wherein the terminal transmits received information for subsequent received signals at least once again after transmitting the received information.

20. A method for enhancing received performance of a terminal which is provided with a broadcasting service from an administration center in a wireless communication system, the method comprising the steps of:
calculating received information for a signal transmitted from a repeater; and
transmitting the received information to the administration center if the received information is equal to or greater than a reference error value

21. The method as claimed in claim 20, wherein the received information is based on at least one of received signal intensity, a packet error rate, an individual bit error rate of a received signal according to the repeaters, and an integrated bit error rate for all repeaters.

22. The method as claimed in claim 20, further comprising the step of transmitting received information for subsequent received signals at least once again after transmitting the received information.
